(19) United States
(12) Patent Application Publication
(10) Pub. No.: US 2020/0390046 A1
(43) Pub. Date: Dec. 17, 2020

(54) OMNI-GRAVITATIONAL HYDROPONICS SYSTEM

(71) Applicants: Ralph Frederick Fritsche, Portland, OR (US); Gioia Donna Massa, Portland, OR (US); John Bernard McQuillen, Portland, OR (US); Portland State University, Portland, OR (US)

(72) Inventors: Mark M. Weislogel, Portland, OR (US); Ralph Frederick Fritsche, Rockledge, FL (US); Gioia Donna Massa, Cape Canaveral, FL (US); John Bernard McQuillen, Parma, OH (US)

(73) Assignee: Portland State University, Portland, OR (US)

(21) Appl. No.: 16/899,403

(22) Filed: Jun. 11, 2020

Related U.S. Application Data
(60) Provisional application No. 62/860,179, filed on Jun. 11, 2019.

(51) Int. Cl. A01G 31/02; A01G 25/16; A01G 27/04

(52) U.S. Cl. CPC A01G 31/02; A01G 27/008; A01G 27/04; A01G 25/16

(57) ABSTRACT

Hydroponics systems and apparatus for operation in zero-gravity and low-gravity environments are disclosed herein. An apparatus can include an elongated main body having an inlet end, an outlet end, and a channel disposed between the inlet end and the outlet end. The channel can include a first portion, and a second portion. The first portion can include surfaces that are inwardly tapered in a direction from the second portion to the first portion. The second portion can include at least one opening such that a portion of a plant can extend through the at least one opening. Fluid can flow through the channel.

### CROSS-REFERENCE TO RELATED APPLICATION

This application claims priority to U.S. Provisional Application No. 62/860,179, filed Jun. 11, 2019, which is incorporated by reference herein.

### ACKNOWLEDGMENT OF GOVERNMENT SUPPORT

This disclosure was made with government support under Grant Number 80NSSC18K0436 awarded by the National Aeronautics and Space Administration. The government has certain rights in the invention.

### FIELD

The present disclosure relates generally to hydroponics systems, and more particularly to hydroponics systems for use in low-gravity environments.

### BACKGROUND

Significant problems exist when attempting to grow plants in low-gravity (e.g., zero-gravity) or reduced-gravity environments. The lack of gravity makes it difficult for plants to receive sufficient hydration and aeration to the plant root zone. Plants require water for nutrient transport, biochemical processes, and thermal management. Aeration is required for the root zone to exchange gases (e.g., CO₂, O₂, etc.) at minimal but necessary levels. Thus, significant challenges exist for systems tasked with passive, semi-passive, and/or active delivery of water, nutrients, and gases to plant root zones in a manner that is highly reliable and effective from an overall resource utilization perspective for plants aboard spacecraft or in environments with reduced gravity (e.g., environments with lower gravity than earth's gravity).

### SUMMARY

Disclosed herein is a hydroponics system for operation in zero-gravity and low-gravity environments. Such a system can comprise one or more components, including various apparatus.

In one representative embodiment, an apparatus comprises an elongated main body having an inlet end, an outlet end, and a channel disposed between the inlet end and the outlet end. The channel comprises a first portion, and a second portion. The first portion comprises surfaces that are inwardly tapered in a direction from the second portion to the first portion. The second portion comprises at least one opening such that a portion of a plant can extend through the at least one opening. Fluid can flow through the channel.

In some embodiments, the apparatus further comprises a third portion. The third portion comprises a circular root accommodation region.

In some embodiments, the inlet end comprises a first inlet port axially aligned with the third portion and a second inlet port axially aligned with the first portion, and the outlet end comprises a first outlet port axially aligned with the third portion and a second upper outlet port axially aligned with the first portion.

In some embodiments, the second portion comprises a removable lid.

In some embodiments, the removable lid has a semi-circular inner surface.

In some embodiments, fluid can enter through the inlet end, flow along the channel, and exit through the outlet end.

In some embodiments, the second portion comprises a non-wetting surface.

In some embodiments, the second portion comprises polytetrafluoroethylene.

In some embodiments, the second portion slopes downward along a length of the main body.

In some embodiments, a system is provided. The system can include an apparatus, a fluid line, and a pump configured to pump liquid through the fluid line and the apparatus.

In some embodiments, the system further comprises at least one valve to control the flow of liquid through the apparatus.

In some embodiments, the system further comprises a third portion, wherein the third portion comprises a circular root accommodation region.

In some embodiments, the inlet end comprises a first inlet port adjacent axially aligned with the third portion and a second inlet port axially aligned with the first portion, the outlet end comprises a first outlet port axially aligned with the third portion and a second outlet port axially aligned with the first portion, and the fluid line is connected to the first inlet port, the second inlet port, the first outlet port, and the second outlet port.

In some embodiments, the system further comprises a first valve to control the flow of fluid through the first inlet port, a second valve to control the flow of fluid through the second inlet port, a third valve to control the flow of fluid through the first outlet port, and a fourth valve to control the flow of fluid through the second outlet port.

In some embodiments, the system further comprises a plunger to add fluid to the fluid line.

In some embodiments, the system further comprises a plunger to remove fluid from the fluid line.

In some embodiments, the system further comprises a plunger to aerate the fluid line.

In some embodiments, the system further comprises a capillary reservoir coupled to the fluid line, wherein the capillary reservoir is configured to store liquid.

The foregoing and other objects, features, and advantages of the disclosure will become more apparent from the following detailed description, which proceeds with reference to the accompanying figures.

### BRIEF DESCRIPTION OF THE DRAWINGS

FIG. 1A shows a side view of an apparatus for growing plants in a low-gravity environment.

FIG. 1B shows a cross-sectional view of the apparatus of FIG. 1A, taken along the line 1B as shown in FIG. 1A.

FIG. 2 shows a side view of another apparatus for growing plants in a low-gravity environment.

FIG. 3 shows a system for growing plants in a low-gravity environment.

FIG. 4 shows another system for growing plants in a low-gravity environment.

FIG. 5 shows another system for growing plants in a low-gravity environment.

FIG. 6 shows another system for growing plants in a low-gravity environment.

FIG. 7 shows a cross-sectional view of a non-occluding conduit with wick.

### DETAILED DESCRIPTION

Previous systems for growing plants in low-gravity environments have used soil-based concepts that exclusively utilize a hydrophilic clay with a wicking material such as the Vegetable Production System (VEGGIE) and the Passive Orbit Nutrient Delivery System (PONDS) to a reservoir, or that is sometimes coupled with a pump-driven porous tube feeder system in “ebb and flow mode,” such as the Advanced Plant Habitat (APH). While these systems are adequate for studying plant science, they require daily monitoring of plant health throughout all stages of plant life with regard to appropriate water consumption rates, are launch-mass intensive, are prone to failure due to root zone flooding and/or pore contamination and plugging, and are not viable for a food production system in a space environment. Specific problems have included insufficient plant hydration that is commensurate with the stage of plant growth, excessive hydration that effectively drowns the plant, insufficient water aeration that starves the plant, excessive hydration that encourages the establishment of opportunistic molds and fungi that are potentially dangerous to both the plant and the crew, and the buildup of nutrient salts along the plant stem that can chemically burn the plant. Accordingly, an improved system for growing plants in low-gravity systems is desirable.

Disclosed herein is a hydroponics system that utilizes recent advances in capillary fluidics research conducted on the International Space Station (ISS) and utilizes methods and materials that exploit novel passive and semi-passive control of poorly wetting capillary liquids that to a large extent mimic the role of gravity for well-established techniques to provide sufficient hydration, aeration, and nutrients to plant root systems on earth. The disclosure herein describes an omni-gravitational hydroponics system that builds upon the concept of a V-groove or ice cream cone technique that was developed and demonstrated in NASA-funded experiments relating to capillary flow (CFE) and capillary channel flow (CCF), which were in part pursued to exploit such geometries to separate gas bubbles from flowing liquids. Such channel geometry-induced capillary flows have also been demonstrated in other low-gravity experiments for similar poorly-wetting aqueous streams (e.g., by the Capillary Structures for Exploration Life Support (CSELS)).

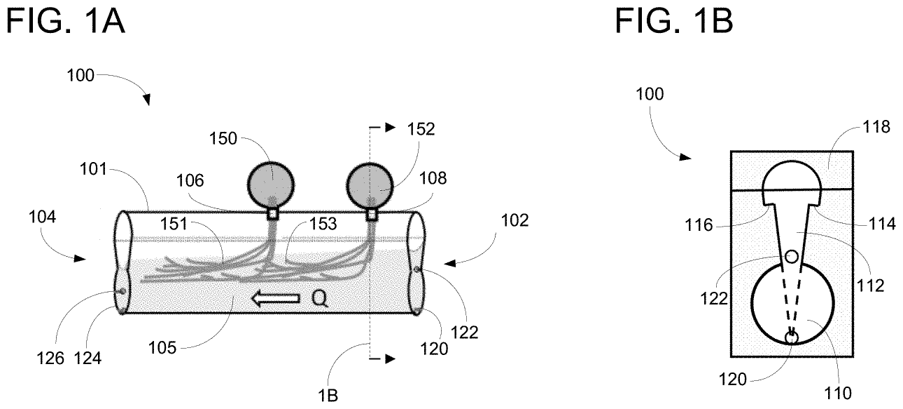

FIG. 1A shows an apparatus 100 for growing plants in a low-gravity environment. The apparatus 100 can be used in a hydroponics system where a mechanically-pumped nutrient/water solution is delivered to and removed from an open channel possessing a cross-section that maintains a stable liquid column with a free surface, above which a plant can grow. The channel possesses characteristics that enable the desired performance despite the local gravity level. As used in this disclosure, reduced-gravity means an environment having gravity less than earth's gravity (e.g., on the moon, aboard the international space station). As used in this disclosure, low-gravity specifies microgravity environments experienced on orbit or during spacecraft coast periods (e.g., ISS, moon and/or mars coasts, etc.).

The apparatus 100 can have an inlet end 102 and an outlet end 104 and an elongated channel 105 extending along the length of the apparatus between the inlet and outlet ends. In operation, liquids (e.g., a solution containing water and/or nutrients) can be mechanically pumped through the apparatus 100 flowing from the inlet end 102 to the outlet end 104.

An upper surface 101 of the apparatus 100 can have openings 106, 108. In some embodiments, the upper surface 101 comprises a lid 118 as described in further detail below. In the illustrated embodiment, plants 150, 152 having roots 151, 153, respectively, can be grown within the apparatus 100. The stems of the plants 150, 152 can extend through the openings 106, 108 such that the roots 151, 153 remain within the apparatus 100 and the leaves and/or flowers of the plants can grow outside of the apparatus.

In the illustrated embodiment of FIG. 1A, apparatus 100 contains two such openings 106, 108 such that two plants can be grown within the apparatus 100. In other embodiments, the apparatus 100 can contain additional openings such that additional plants can be grown in the apparatus. In some embodiments, the apparatus can contain a single opening with only one plant grown within the apparatus.

FIG. 1B shows a cross-sectional view of the apparatus 100 taken along the line 1B as shown in FIG. 1A. The unique geometry of the apparatus 100, as shown in the cross-section of FIG. 1B, allows plants to grow within the apparatus in low-gravity environments, as disclosed herein. Inertia, capillary, and when present, gravity forces can all play a role in a stable flow process to various degrees depending on the plant/system requirements and environments.

A first portion of the apparatus 100 (e.g., a lower portion in the orientation of FIGS. 1A-1B) comprises a root accommodation region 110. In the illustrated embodiment, the root accommodation region 110 has a circular cross section and extends along the length of the apparatus 100 in a cylindrical shape. The root accommodation region 110 provides space for roots 151, 153 to occupy as the plants 150, 152 mature. In some embodiments, the root accommodation region 110 can taper in the general flow direction to enhance liquid accumulation towards the exit port.

A second portion 112 of the apparatus 100 (e.g., a middle portion in the orientation of FIGS. 1A-1B) comprises a tapered cross-section that tapers inward in a direction from the top of the apparatus toward the bottom of the apparatus in the orientation of FIGS. 1A-1B. In the illustrated embodiment, the middle portion 112 can tapered at an angle of less than 20 degrees and in particular embodiments can be tapered at an angle of 15 degrees.

The tapered cross-section of the middle portion 112 can establish a capillary pressure gradient along the length of the channel 105 such that liquid input at the inlet end 102 is wicked and/or otherwise convected along the channel to the outlet end 104. The upper end of the middle portion 112 can comprise interior edges 114, 116.

When liquid is filled to the middle portion 112 of the apparatus 100, withdrawal of liquid from the channel 105 lowers the meniscus elevation, thereby decreasing the capillary pressure. This draws deeper, higher pressure upstream liquid, thus creating a capillary pressure gradient along the channel 105. This capillary pressure gradient causes liquid within the channel 105 to be passively pumped through the channel.

In the illustrated embodiment, the apparatus 100 comprises a removable lid 118. In some embodiments, the lid 118 is not present. In the illustrated embodiment, the lid 118 comprises a semi-circular shape. In other embodiments, the lid 118 can comprise any poorly or non-wetting shape. In some embodiments, the inner surface of the lid 118 is coated with a non-wetting material, such as polytetrafluoroethylene (PTFE), to enhance stable liquid configurations below a pinning lip of the channel. Superhydrophobic wetting conditions are achieved when exploiting architecture surface roughness. As used herein, the term non-wetting refers to a contact angle between a liquid and a solid of greater than 90 degrees. Superhydrophobic non-wetting surface treatments and coatings are preferred where contact angles are typically greater than 150 degrees. The circular shape of the lid 118 can retard liquid accumulation within the lid.

As water flows from the inlet end 102 to the outlet end 104 due to the capillary forces, the roots 151, 153 of the plants 150, 152 can draw needed water volumes for evapo-transpiration and any excess water can be recirculated. In some embodiments, aeration devices such as a gas pump or passive venturi can be included upstream. In other embodiments, the primary pump flow rate can be increased such that bubbles are naturally ingested at the outlet end 104, which can accomplish passive aeration despite the local gravity environment.

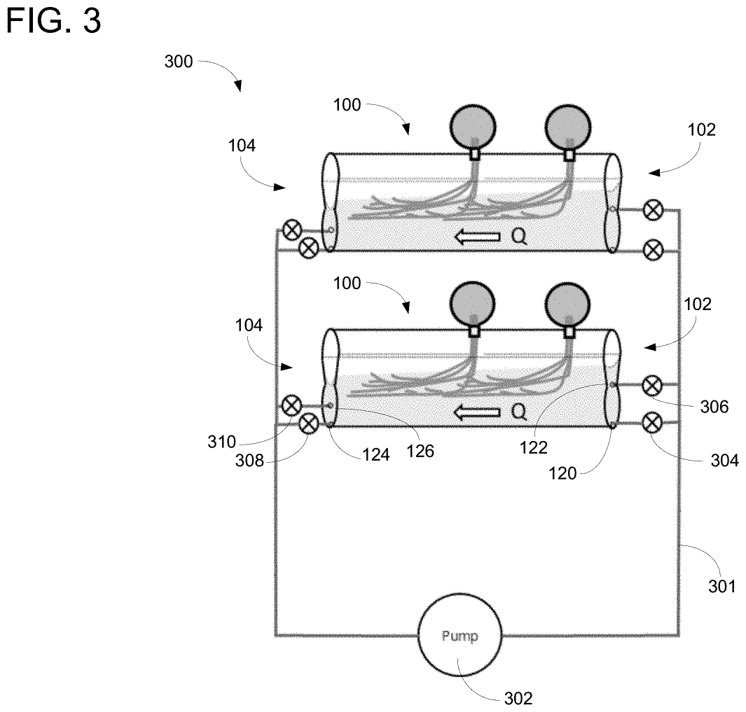

In the illustrated embodiment, the apparatus 100 has a lower inlet port 120 and an upper inlet port 122 at the inlet end 102 and a lower outlet port 124 and an upper outlet port 126 at the outlet end 104. The lower inlet port 120 can be used for priming as described in further detail below in connection with FIG. 3 and the upper inlet port 122 can be used for normal operation.

The materials that comprise the apparatus 100 can be chosen based on wetting properties and bio-compatibility. In some embodiments, lightweight polymers can be used. In other embodiments, metallic or ceramic materials can be used. All substrates can be coated with superhydrophobic surface coatings or surface modified monolithic materials (e.g., PTFE) to enhance non-wetting where desired to improve passive fluid control. Coated and/or non-coated fabrics can be applied to the interior of the apparatus 100 to enhance wicking while also enhancing air-water exposure to improve passive aeration. In some embodiments, hybrid surfaces can be constructed to achieve super-hydrophilic surfaces where desired. Such surfaces can be 3D printed directly onto otherwise monolithic substrates creating hemi-wicking substrates, or fabrics, screens, or other meshes can be mated to a monolithic surface to create similar favorable wicking conditions.

Fluid properties can vary broadly from clean water to liquids with dissolved nutrient additives. Additives that dramatically decrease surface tension and contact angle can enhance or retard the maximum flow rate limits of the channel 105. The size and geometry of the channel 105 can be based on the plant requirements specified by plant physiologists. Once these requirements are established, the channel size, wedge angle, length, wetting conditions, etc. can be computed from analytical design tools developed over the years in connection with NASA-funded experiments. Improper channel dimensions can reduce the performance of the apparatus 100.

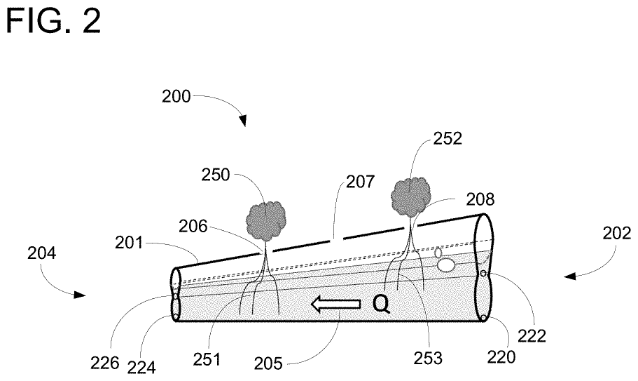

FIG. 2 shows an apparatus 200 for growing plants in a low-gravity environment. The apparatus 200 is constructed in a similar manner as the apparatus 100 of FIG. 1 except that it has an upper surface 201 that is tapered or sloped downward in the orientation of FIG. 2. This creates a downward sloping channel 205 between the inlet end 202 and the outlet end 204. This can improve the performance of the apparatus as explained below.

The apparatus 200 can comprise lower and upper inlet ports 220, 222 and lower and upper outlet ports 224, 226. The apparatus 200 can comprise openings 206, 207, 208 in the upper surface 201 that plant stems can extend through. In the illustrated embodiment of FIG. 2, plants 250, 252 are shown extending through openings 206, 208 with roots 251, 253 extending into the channel 205. In some embodiments, an additional plant can extend through opening 207. In the illustrated embodiments, the openings 206, 207, 208 have a width of 3 mm. In other embodiments, the openings can have a greater or smaller width.

The downward sloping channel 205 can provide for a passive capillary fluid reorientation mechanism in the event of a disruptive upset to the apparatus 200 (for example, being bumped by a crew member or jostled by sudden motion of a spacecraft). By covering the outlet end 204, liquid can be drawn by a pump and injected into the inlet end 202 to re-establish capillary connection along the channel 205.

FIG. 3 shows a schematic diagram of a low-gravity hydroponics system 300. In the illustrated embodiment of FIG. 3, the system 300 comprises two apparatus 100 in parallel. In other embodiments, the system 300 can comprise a single apparatus 100, additional apparatus 100 in parallel, or any number of apparatus 100 in series. In some embodiments, the system 300 can include some number of apparatus 200 instead of apparatus 100.

In the illustrated embodiment of FIG. 3, the system 300 can comprise a fluid line 301 and a pump 302 that can mechanically pump liquid through the fluid line and the system. The pump 302 can pump liquid such that it flows into the inlet end 102 of the apparatus 100 in the system 300. Once liquid enters an apparatus 100, the inertia from the pump as well as the capillary pressure gradient described above can cause the liquid to move through the channel in the apparatus to the outlet end 104.

In low-gravity environments, capillary and inertial forces can be exploited to maintain a desired liquid flow rate along the open channel in the apparatus 100. However, the system and apparatus described herein can also be used in gravitational environments (e.g., on earth, moon, Mars, etc.). In environments where gravity is present (where the direction of the strongest gravitational force is downward in the orientation of FIG. 3), gravity introduces an additional hydrostatic pressure gradient in the flow channel, thereby flattening the elevation of the interface along the channel without altering the flow rate. Not all gravity levels change the pump flow rate of the system 300 but the presence of gravity can enhance the stability of the system. This can be demonstrated with an open channel geometry as found in commercial hydroponics systems on earth. Non-zero gravity environments also allow a higher flow rate air ingestion limits for the channel. Negative gravity values can be tolerated provided that g>−σ/ρR(1+R/L)*L, where σ is surface tension, ρ is liquid density, R and L are the characteristic dimensions of the free surface accounting for plant-root wicking impacts, with L as the hydrostatic head of the system. Larger negative values can destabilize the interface.

Due to the stability of such open channel flow, the channels may be plumbed in parallel, as shown in FIG. 3 with the two parallel apparatus 100. This can exploit the manner in which the system 300 adapts to the changing requirements of plants therein, which can allow a variety of deployments to optimize plant layout and density. To increase plant density, multiple plants can be employed along each capillary channel, as shown in FIG. 3. However, because the capillary length for each channel is limited by the capillary pumping force and viscous resistance, parallel channels can be employed to significantly increase both the number of plants grown and the plant density for efficient use of real estate and resources (e.g., cabin volume, lighting arrangements, etc.). When employing parallel channels, multiply-interrupted flows along each channel by any variety of root geometries and variety in water uptake rates between plants can vary both flow and fill levels and can limit the maximum system flow rate, which can potentially lead to instabilities in the overall system flow distribution. Lower system flow rates have less exposure to this potential problem.

The system 300 can also have valves 304, 306, 308, 310 that can open and close to control the flow of liquid through the apparatus 100. The valve 304 can control the flow into lower inlet port 120, the valve 306 can control the flow into upper inlet port 122, the valve 306 can control the flow from lower outlet port 124 and the valve 310 can control the flow from upper outlet port 126. During an initial priming stage, valves 304 and 308 can be open such that liquid flows through lower inlet port 120 and lower outlet port 124. Then, valves 304 and 308 can be closed and valves 306, 310 can be opened such that liquid flows through upper inlet port 122 and upper outlet port 126 during normal operation. In other embodiments, different flow patterns can be used (for example, with all valves 304, 306, 308, 310 open).

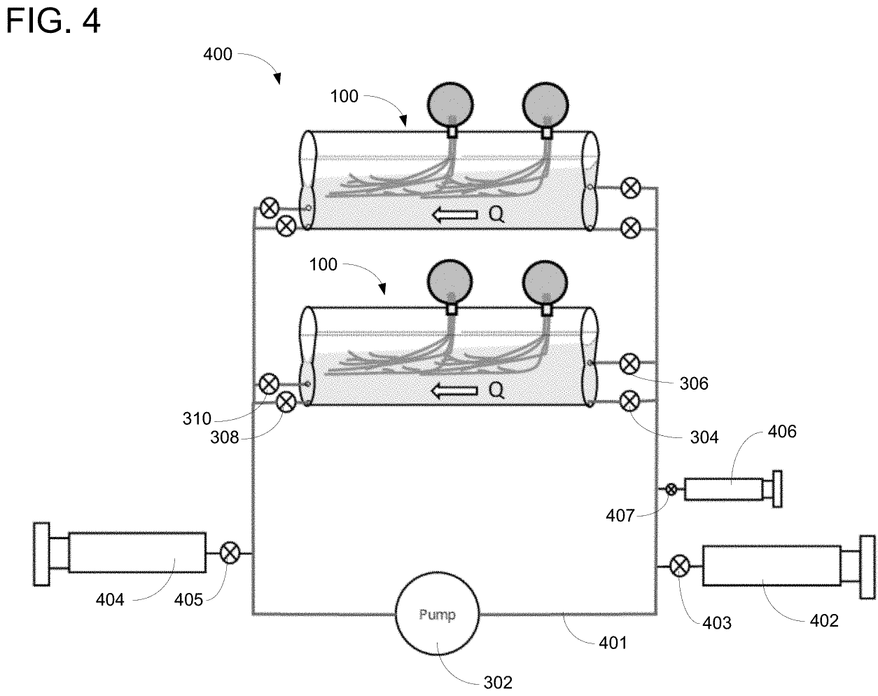

FIG. 4 shows a schematic diagram of a low-gravity hydroponics system 400. The system 400 is similar to the system 300 except that the system 400 includes plungers 402, 404, and 406 (e.g., syringes). Plunger 402 is a liquid plunger that can be used to inject liquids (e.g., plant nutrients) into a fluid line 401. A valve 403 can open and close based on whether the plunger 402 is being used. Plunger 404 is a liquid plunger that can be used to withdraw liquid from the fluid line 401. A valve 405 can open and close based on whether the plunger 404 is being used. The plunger 406 is an air plunger that can aerate the fluid line 401. A valve 407 can open and close based on whether the plunger 406 is being used. In some embodiments, any of the plungers 402, 404, 406 can be replaced with an automated system for injecting and/or withdrawing liquids and/or air.

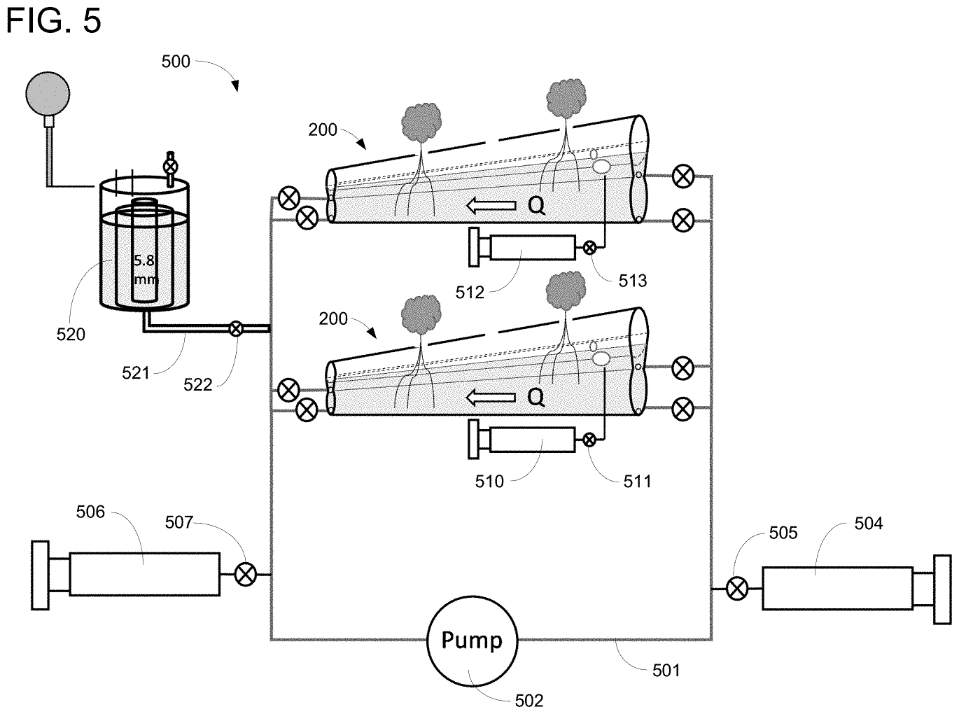

FIG. 5 shows a schematic diagram of a low-gravity hydroponics system 500. The system 500 comprises two apparatus 200 in parallel. In other embodiments, the system 500 can comprise a single apparatus 200, or additional apparatus 200 in parallel and/or in series. In some embodiments, one or more of the apparatus 200 can be replaced with the apparatus 100. A fluid line delivers liquid to each of the apparatus 200 and a pump 502 can pump liquid through the fluid line 501. A plunger 504 can be used to add liquid through a valve 505 to the fluid line 501. A plunger 506 can be used to remove liquid through a valve 507 from the fluid line 501. Plunger 510 can be used to aerate the lower apparatus 200 through valve 511 and plunger 512 can be used to aerate the upper apparatus 200 through valve 513.

The system 500 can further comprise a capillary reservoir 520 connected to fluid line 501 through auxiliary fluid line 521. The capillary reservoir 520 can be partially filled with liquid (e.g., water with nutrients). Valve 522 can be opened or closed to connect or disconnect the reservoir 520 to the fluid line 501. When the valve 522 is open, if the fluid volume in the apparatus 200 is reduced through evaporation or other mechanisms, the fluid can be replenished with liquid from the reservoir 520. Furthermore, excess fluid build-up in the apparatus 200 can be drained to the reservoir 520.

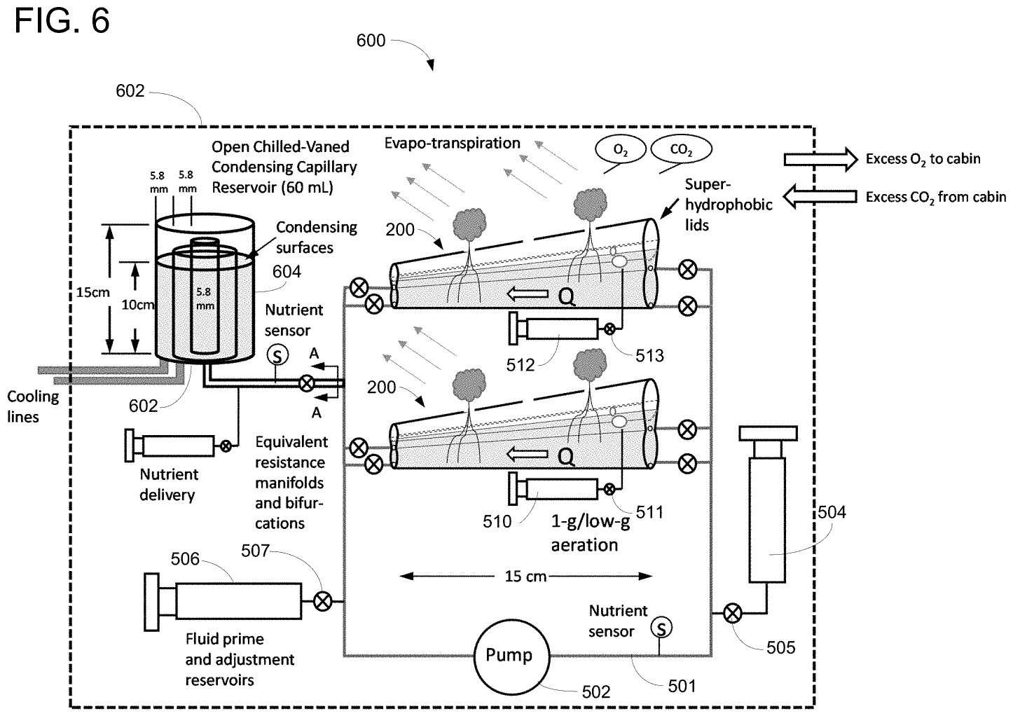

FIG. 6 shows a schematic diagram of a low-gravity hydroponics system 600. The hydroponics system 600 contains many of the same elements as the hydroponics system 500 of FIG. 5 and the same references numbers are used for the same features. In the embodiment of FIG. 6, the system 600 comprises an insulated habitat enclosure 602. The components of system 600 are contained within the interior of the enclosure 602. The interior of the enclosure 602 can be climate controlled for desired set points of certain conditions (e.g., temperature, pressure, relative humidity, etc.). The enclosure 602 can contain certain features to affect the interior conditions such as fans, grow lighting, etc.

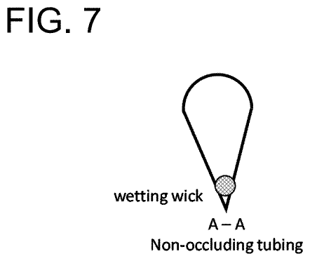

The hydroponics system 600 can comprise an open, opaque, chilled, vaned, condensing capillary reservoir 604. The reservoir 604 can be externally cooled to promote condensation along the fins of the device that also serve as capillary containment and wicking devices. Because the reservoir 604 is open to the humid environment of the plant growth chamber, film and/or dropwise condensation occurs on the vanes. The condensate accumulates bridging the vane structures and is progressively wicked into and contained within the capillary vane structure of the reservoir. The spacing of the vanes is such that a uniform capillary curvature (i.e., pressure) is established that balances the desired capillary pressure of the parallel channels at a set point liquid fill level. As liquid is transported out of the flow loop through evapo-transpiration of the plants, the pressure in the liquid reduces and liquid is passively added to the system via the reservoir. Capillary connection is maintained through continuous non-occluding tubing (see FIG. 7). The non-occluding tube and wick structure provide bubble-tolerant transport of liquid from the reservoir to the primary loop. The wettability of the wick can vary. For example, the wick can have high wettability in some embodiments. In other embodiments, the wick can be perfectly wetting. The perfectly wetting wick assures critical geometric interior corner wetting of the conduit section, which in turn bypasses bubble resident in the conduit. Such bubbles are also more free to be convected downstream and out of the flow. The evaporated liquid re-condenses in the condensing reservoir closing the water cycle.

Excess O2 is produced by the plants and may be sequestered to the crew cabin or other sink. Excess CO2 is required by the plants and may be sequester from the crew cabin or other source. The reservoir 604 can be shielded by filter (e.g., HEPA) to guard against contamination. It can consist of opaque materials to shield against light leading to microbial growth. It can contain biocidal surfaces (i.e., silver, sharkskin, etc.) to resist contamination via growth of biofilms, fungi, etc.

Non-occluding conduit is employed where practicable, especially between the reservoir and the fluid loops to assure continuous capillary pressure connection between parallel fluid lines and reservoir. A flexible polymeric tubing of the section is capable of such performance. Any number of specialty valves can be employed for such application including pinch valves. A perfectly wetting wick structure (e.g., nylon string, rayon felt, etc.) may be employed along the interior corner vertex of such conduit to enhance critical geometric wetting within it maintaining a flow path past partially occluding bubbles should they reside there.

For purposes of this description, certain aspects, advantages, and novel features of the embodiments of this disclosure are described herein. The disclosed methods, apparatus, and systems should not be construed as being limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Although the operations of some of the disclosed embodiments are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one of ordinary skill in the art having the benefit of this disclosure.

It should also be noted that although in some instances dimensions and/or particular configuration are disclosed, the dimensions and/or configurations can be varied unless explicitly state otherwise herein.

All features described herein are independent of one another and, except where structurally impossible, can be used in combination with any other feature described herein. For example, the apparatus 100 as shown in FIG. 1A can be used in combination with the system 500 as shown in FIG. 5. In other embodiments, the apparatus 200 shown in FIG. 2 can be used in combination with the systems 300 and 400 shown in FIGS. 3 and 4, respectively.

As used in this application and in the claims, the singular forms “a,” “an,” and “the” include the plural forms unless the context clearly dictates otherwise. Additionally, the term “includes” means “comprises.” Further, the term “coupled” generally means physically, mechanically, chemically, magnetically, and/or electrically coupled or linked and does not exclude the presence of intermediate elements between the coupled or associated items absent specific contrary language. As used in this application, directional terms such as “upper” or “lower” can be rotated and considered to be in different orientations.

In view of the many possible embodiments to which the principles of the disclosed technology may be applied, it should be recognized that the illustrated embodiments are only examples and should not be taken as limiting the scope of the claims. Rather, the scope of the claimed subject matter is defined by the following claims and their equivalents.

1. An apparatus comprising:
an elongated main body having an inlet end;
an outlet end; and
a channel disposed between the inlet end and the outlet end, wherein the channel
comprises:
a first portion; and
a second portion;
wherein the first portion comprises surfaces that are inwardly tapered in a direction from the second portion to the first portion;
wherein the second portion comprises at least one opening such that a portion of a plant can extend through the at least one opening; and
wherein fluid can flow through the channel.

2. The apparatus of claim 1, further comprising a third portion, wherein the third portion comprises a circular root accommodation region.

3. The apparatus of claim 2, wherein the inlet end comprises a first inlet port axially aligned with the third portion and a second inlet port axially aligned with the first portion, and the outlet end comprises a first outlet port axially aligned with the third portion and a second upper outlet port axially aligned with the first portion.

4. The apparatus of claim 1, wherein the second portion comprises a removable lid.

5. The apparatus of claim 4, wherein the removable lid has a semi-circular inner surface.

6. The apparatus of claim 1, wherein fluid can enter through the inlet end, flow along the channel, and exit through the outlet end.

7. The apparatus of claim 1, wherein the second portion comprises a non-wetting surface.

8. The apparatus of claim 1, wherein the second portion comprises polytetrafluoroethylene.

9. The apparatus of claim 1, wherein the second portion slopes downward along a length of the main body.

10. A system comprising:
the apparatus of claim 1;
a fluid line; and
a pump configured to pump liquid through the fluid line and the apparatus.

11. The system of claim 10, further comprising at least one valve to control the flow of liquid through the apparatus.

12. The system of claim 10, further comprising a third portion, wherein the third portion comprises a circular root accommodation region.

13. The system of claim 12, wherein:
the inlet end comprises a first inlet port adjacent axially aligned with the third portion and a second inlet port axially aligned with the first portion;
the outlet end comprises a first outlet port axially aligned with the third portion and a second outlet port axially aligned with the first portion; and
the fluid line is connected to the first inlet port, the second inlet port, the first outlet port, and the second outlet port.

14. The system of claim 13, further comprising a first valve to control the flow of fluid through the first inlet port, a second valve to control the flow of fluid through the second inlet port, a third valve to control the flow of fluid through the first outlet port, and a fourth valve to control the flow of fluid through the second outlet port.

15. The system of claim 10, further comprising a plunger to add fluid to the fluid line.

16. The system of claim 10, further comprising a plunger to remove fluid from the fluid line.

17. The system of claim 10, further comprising a plunger to aerate the fluid line.

18. The system of claim 10, further comprising a capillary reservoir coupled to the fluid line, wherein the capillary reservoir is configured to store liquid.
